(19) United States
(12) Patent Application Publication
(10) Pub. No.: US 2014/0232694 A1
(43) Pub. Date: Aug. 21, 2014

(54) Sensing Strip for Providing Touch and Gesture Controls

(71) Applicant: MOTOROLA MOBILITY LLC, Libertyville, IL (US)

(72) Inventors: Rachid Mohsen Alameh, Crystal Lake, IL (US); Patrick J. Cauwels, South Beloit, IL (US); Timothy Dickinson, San Diego, CA (US); Kenneth A. Paitl, West Dundee, IL (US)

(73) Assignee: Motorola Mobility LLC, Libertyville, IL (US)

(21) Appl. No.: 13/770,259

(22) Filed: Feb. 19, 2013

(51) Int. Cl. G06F 3/042; G01J 5/20

(52) U.S. Cl. CPC G06F 3/042; G01J 5/20
USPC 345/175; 250/338.4

(57) ABSTRACT

An infrared sensing strip includes a substantially linear substrate board, a receiver diode, and a plurality of light emitting diodes (LEDs) linearly aligned along the linear substrate board. Each of the LEDs is operative to transmit in a different direction. The infrared sensing strip utilizes prismatic films arranged to refract light from each of the LEDs in different directions. In one embodiment, the receiver diode is positioned centrally on the linear substrate board, and includes at least four LEDs, with two of each being disposed on either side of the receiver diode. Four prismatic films each cover a respective one of the LEDs and are arranged to refract light from each respective LED in one of four different directions. The small scale of the infrared sensing strip enables various applications including a scroll control, volume control, a heart rate monitor and various transmit and receive features.

### FIELD OF THE DISCLOSURE

The present disclosure relates generally to infrared transmitters and receivers and more particularly to touch or gesture based controls.

### BACKGROUND

Mobile electronic devices have become smaller in size over the years due to advances in miniaturization techniques for circuits and other components required to implement the devices. The smaller a device becomes, the more challenges arise with respect to physical size limitations and usability. As devices are reduced to sizes considered “wearable,” such wearable devices may still include displays. For such wearable devices the implementation of touchscreen controls on the display becomes troublesome because, among other problems, the display may be easily blocked by the user's finger during use making it difficult for the user to see what they are doing.

### BRIEF DESCRIPTION OF THE DRAWINGS

FIG. 1 is an axonometric view of an infrared sensing strip in accordance with an embodiment.

FIG. 2 is an axonometric view and partial cutaway view of an infrared sensing strip showing a stack-up in accordance with an embodiment.

FIG. 3 is top view of an infrared sensing strip substrate in accordance with an embodiment.

FIG. 4 is top view of an infrared sensing strip showing the top lens in accordance with an embodiment.

FIG. 5 is side view of an infrared sensing strip showing the stack-up in accordance with an embodiment.

FIG. 6 is an axonometric view of a wearable device with the housing removed to show the position of an infrared sensing strip with respect to a display in accordance with an embodiment.

FIG. 7 is an axonometric view of a wearable device having an infrared sensing strip in accordance with an embodiment.

FIG. 8 is a partial schematic diagram of a mobile device, which may also be a wearable device, in accordance with various embodiments, and an external apparatus which may have an infrared sensing strip in accordance with various embodiments.

FIG. 9 is a pulse timing diagram showing interference avoidance between infrared data bursts and other visual light indicators in accordance with various embodiments.

FIG. 10 is a flow chart showing methods of operation of a mobile device having an infrared sensing strip in accordance with various embodiments.

FIG. 11 is a flow chart showing methods of operation of a mobile device having an infrared sensing strip in accordance with various embodiments.

FIG. 12 is a flow chart showing methods of operation of a mobile device having an infrared sensing strip in accordance with various embodiments.

### DETAILED DESCRIPTION

The present disclosure provides among other things a narrow infrared strip having a stack-up size suitable for use in wearable mobile devices that are, for example, small enough to be worn on a user's wrist, or as a pendant or brooch, etc. The infrared strip may be positioned to one side of a display in the mobile device to enable control functions such as scrolling, volume control, etc., without obstructing view of the display by the user's finger. The infrared strip is also particularly advantageous for use in portable or wearable heart rate monitors.

An embodiment includes a substantially linear substrate board, a receiver diode, and light emitting diodes (LEDs) linearly aligned along the linear substrate board. Each LED is operative to transmit in a different direction.

The infrared sensing strip utilizes prismatic films, with each prismatic film covering a respective one of the LEDs. The prismatic films are arranged to refract light from each respective LED in one of the different directions.

In one embodiment, the receiver diode is positioned centrally on the linear substrate board and at least four LEDs are used with two of each being disposed on either side of the receiver diode. Four prismatic films each cover a respective LED and are arranged to refract light from each respective LED in one of four different directions.

The infrared sensing strip may further include an optical isolation shield surrounding the receiver diode and a lens covering the LEDs. The stack-up includes at least one spacing layer between the linear substrate board and the lens.

A mobile device may incorporate the infrared sensing strip and may also have a touchscreen display. The infrared sensing strip may be positioned to one side of the touchscreen display such that the infrared sensing strip is operable as a user interface without obstructing the display from view by the user's finger.

In one embodiment a mobile device includes heart rate monitor logic operatively coupled to the infrared sensing strip. The heart rate monitor logic is operative to measure a heart rate in response to a human finger placed upon a surface of the infrared sensing strip.

Another embodiment includes sensing and control logic operatively coupled to the infrared sensing strip. The sensing and control logic is operative to provide an increase or decrease control signal in response to motion over the infrared sensing strip in a given direction. In some embodiments the sensing and control logic is also operative to detect a beacon signal via the infrared sensing strip and return information using the infrared sensing strip to transmit the information.

In one embodiment a mobile device includes a wrist band connected to a housing of the mobile device, where the infrared sensing strip is housed within the wrist band.

In one embodiment a mobile device is a camera and the sensing and control logic is operative to provide the increase or decrease control signal to control the camera lens to zoom in or out, respectively. The sensing and control logic is also operative to provide the increase or decrease control signal to control an audio volume in various embodiments, or to control scrolling on the touchscreen display.

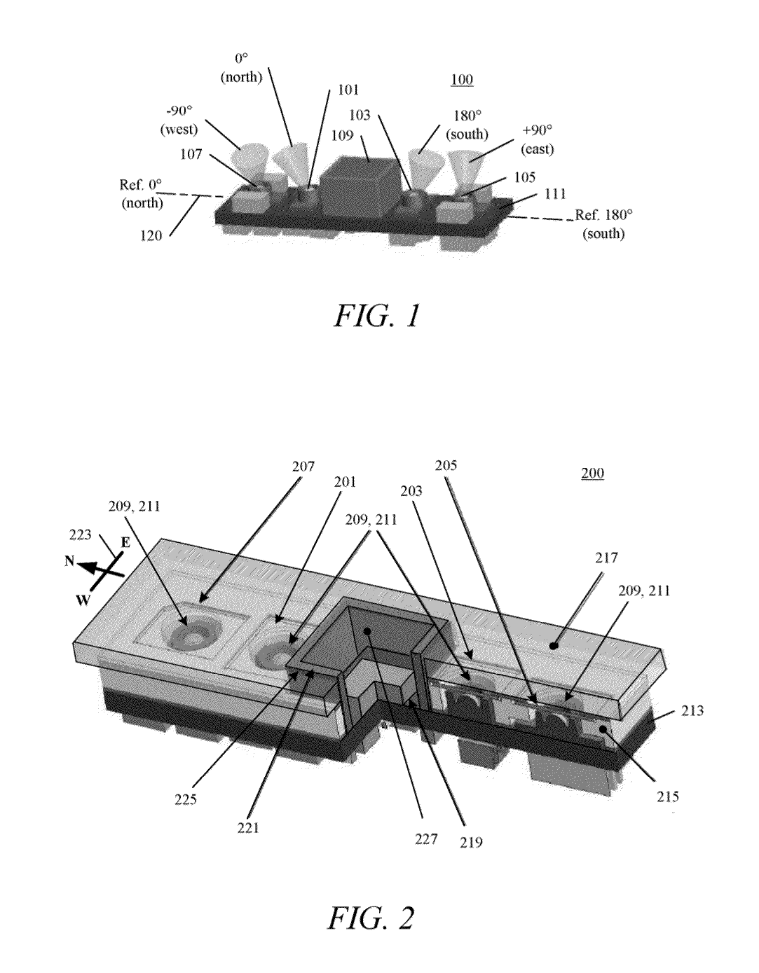

Turning now to the drawings wherein like numerals represent like components, FIG. 1 illustrates an infrared sensing strip 100 that includes a substantially linear substrate 111. The substrate 111 is substantially linear in that the length is greater than the width. For example the length may be at least twice the width or greater. The substantially linear substrate 111 is substantially linear so that a set of light emitting diodes (101, 103, 105 and 107) and at least one photodiode 109 may be linearly aligned along the substantially linear substrate 111 as shown. That is, the set of light emitting diodes are substantially linearly aligned in that they are positioned sequentially along a hypothetical reference axis 120, although not necessarily exactly aligned on the hypothetical reference axis 120. That is, the light emitting diodes may be positioned to one side or the other with respect to the hypothetical reference axis 120. The substantially linear substrate 111 may be any suitable substantially linear shape such as rectangular, a parallelogram or elliptical. Each light emitting diode of the set of light emitting diodes is operative to transmit light in a different direction. The “light cones” shown in FIG. 1 illustrate an example of the directions in which the light emitting diodes may be operative to shine. Referring to the left side end of the substantially linear substrate 111 shown in FIG. 1 as 0° (i.e. “north”) with respect to the hypothetical reference axis 120, the light emitting diodes (LEDs) are operative to shine at 0° (“north” LED 101), 180° (“south” LED 103), +90° (“east” LED 105) and −90° (“west” LED 107), that is, in four primary directions, which are orthogonal directions relative to each other.

An axonometric view in FIG. 2 provides a partial cutaway view of an infrared sensing strip 200 and shows details of an example stack-up in accordance with an embodiment. The stack-up includes a substantially linear substrate 213 such as a printed circuit board (PCB) and may be a single layer PCB or may consist of PCB layers having conductors running between the layers as understood by those of ordinary skill. Four LEDs 209 include respective LED mounting sockets 211 and are mounted and linearly aligned along the substantially linear substrate 213. A photodiode 219 is positioned centrally on the substantially linear substrate 213 and serves as a receiver diode for reflected light from the LEDs 209. The photodiode 219 is surrounded by an optical isolation shield 221 which may have a substantially square cross-section as shown, or may have a rectangular or circular cross-section.

Each of the LEDs 209 is covered by a prismatic film which has refractive properties that direct the light from each LED 209 in a specific direction. The directions may be in four principal directions with respect to (i.e. relative to) the infrared sensing strip 200 orientation as shown by the axes 223 which correspond to the axes of the infrared sensing strip 200 along the length (north and south) and width (east and west). It is to be understood however, that the directions “north,” “south,” “east,” and “west” are used herein as illustrative relative directions only for purposes of explanation. For example, prismatic film 207 is oriented to direct light in the west direction, prismatic film 201 is oriented to direct light in the north direction, prismatic film 203 is oriented to direct light in the south direction, and prismatic film 205 is oriented to direct light in the east direction. That is, the light directions of the two LEDs on either side of the photodiode 219 are relatively orthogonal to each other. This design allows the LEDs to be positioned closely to each other while avoiding interference. It is to be understood that the orthogonal directions need not be oriented or aligned with the axes of the infrared sensing strip 200 but may be oriented using any suitable point of reference. An advantage of the prismatic films is that the LEDs 209 may be positioned vertically and substantially orthogonal with respect to the substantially linear substrate 213 using the respective LED mounting sockets 211 without the need to physically tilt any of the LEDs 209. The prismatic film may be a commercially available product that, for example, directs light at a refraction angle of 20° as measured from the surface normal of the prismatic film and that has a nominal thickness of less than 200 μm.

The infrared sensing strip 200 stack-up is completed by one or more spacing layers 215, and a lens 217 which covers at least the LEDs 209 and the prismatic films of the stack-up. The photodiode 219 may also have a separate lens 227 to fill the space above the photodiode 219 and provide protection from debris. The lens 227 may be square as shown or may have any suitable shape such as a rectangular, parallelogram, circle, ellipse, etc. depending upon design of the housing into which the infrared sensing strip 200 may be installed. The spacing layers may be formed from any suitable non-conductive material. The spacing layers 215 and the lens 217 may each have a cutout 225 sized to allow the optical isolation shield 221 to fit within. The lens 217 may be formed from a suitable transparent thermoplastic polymer such as a polycarbonate. In some embodiments, the polycarbonate may have a transparent hard coating applied to improve scratch-resistance of the material. The lens 217 may be rectangular as shown or may have any suitable shape such as a parallelogram, ellipse, etc. depending upon design of the housing into which the infrared sensing strip 200 will be installed.

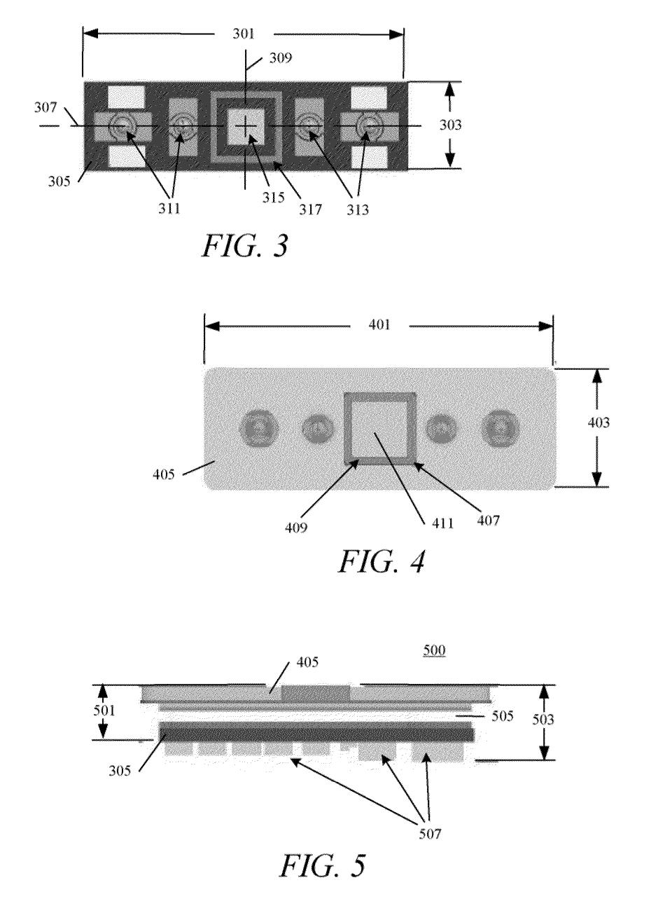

FIG. 3 is top view of an infrared sensing strip substantially linear substrate 305 which is a PCB in accordance with an embodiment. The substrate 305 is substantially linear in that the length 301 is greater than the width 303. In one example embodiment, the length 301 may be approximately 18.0 mm and the width 303 may be approximately 5.0 mm. Although the substantially linear substrate 305 is shown as rectangular in the example of FIG. 3, any other suitable substantially linear geometry may be used such as a parallelogram or ellipse or some other substantially linear geometry. Two LED pairs 311 and 313 are shown linearly aligned along the lengthwise centerline 307 and each LED pair is disposed on one side of the photodiode 315 which is the receiver diode. The photodiode 315 and an optical isolation shield 317 are both positioned centrally about the lengthwise centerline 307 and widthwise centerline 309 of the substantially linear substrate 305.

FIG. 4 is top view of an infrared sensing strip showing the top lens 405 in accordance with an embodiment. As discussed above, the lens 405 may be formed from a suitable transparent thermoplastic polymer such as a polycarbonate, and may also have a transparent hard coating applied for added scratch-resistance. The lens 405 may be rectangular as shown or may have any suitable shape such as a parallelogram, ellipse, or some other substantially linear geometry, or other geometry, depending upon design of the housing into which the infrared sensing strip will be installed. The example rectangular lens 405 may have rounded or beveled corners in some embodiments. In one example embodiment, the length 401 may be approximately 20.0 mm and the width 403 may be approximately 7.0 mm. The lens 405 may have a cutout 407 to allow the optical isolation shield 409 to fit within the cutout 407 and possibly protrude slightly through the lens 405. Any such protrusion would be on the order of micrometers. An additional lens 411 may be provided to fill the space within the optical isolation shield 409 above the photodiode to cover the photodiode and provide protection from debris. The lens 411 may be square as shown or may have any suitable shape such as a rectangular, parallelogram, circle, ellipse, etc. depending upon design of the housing into which the infrared sensing strip will be installed as discussed above with respect to FIG. 2.

FIG. 5 is side view of an IR linear sensing strip 500 showing the stack-up in accordance with an embodiment. In one example embodiment, the stack-up height 501 measured from the bottom of the substrate 305 to the top of the lens 405, and including at least one spacing layer 505, is less than 4.0 mm, for example 3.25 mm, that is, between 3.0 mm and 4.0 mm. The total stack-up height 503 measured from the top of the lens 405 to the bottom of a largest circuit component of the circuit components 507 protruding from the bottom of the substrate 305, is between 4.0 and 5.0 mm, for example, 4.38 mm.

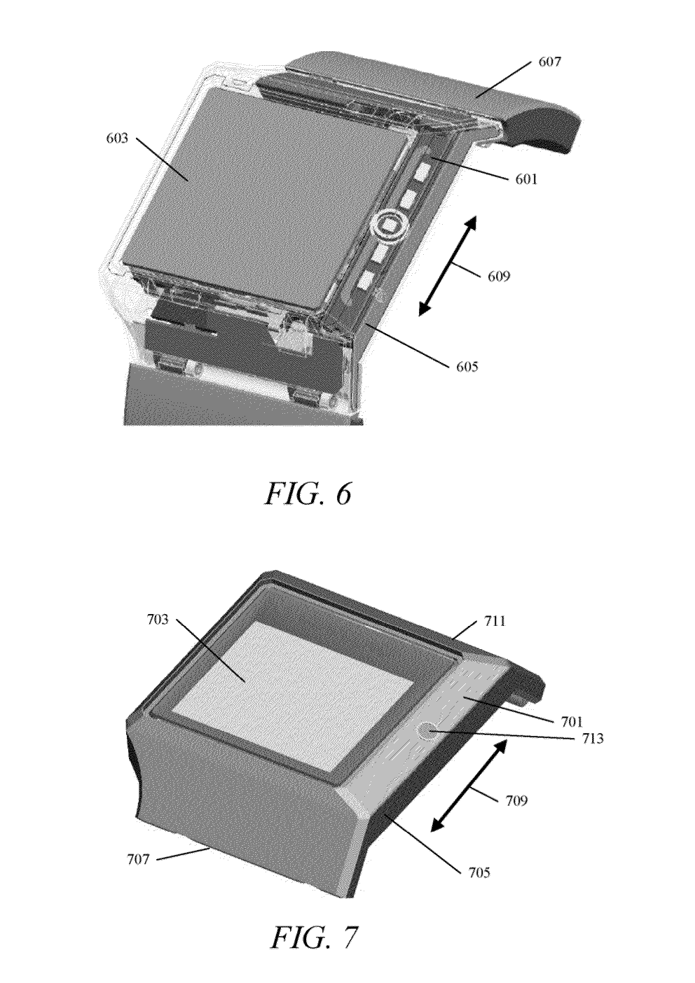

FIG. 6 is an axonometric view of a wearable device with the housing 605 cover removed to show the position of an IR linear sensing strip 601 with respect to a display 603 in accordance with an embodiment. The housing 605 may be connected to a wristband 607 which may be flexible. The IR linear sensing strip 601 is mounted in the housing 605 and positioned to one side of the display 603 such that a user may slide the user's finger across the IR linear sensing strip 601 in the directions shown by the arrows 609 to invoke various control functions. The user may also place a finger on the IR linear sensing strip 601 or may tap the IR linear sensing strip 601 at various positions to invoke selection control or other features. It is to be noted that the IR linear sensing strip 601 is operable by the user without causing obstruction of the display 603. Various features may be implemented using the IR linear sensing strip 601 such as, but not limited to, scrolling, volume control, camera zoom control, selection, etc., and a heart rate monitor. The display 603 may be a touchscreen display in some embodiments. Also, in some embodiments the IR linear sensing strip 601 may be positioned on the wristband 607 and connected to the circuitry within the housing 605 using a flexible connector (not shown).

FIG. 7 shows a similar wearable device complete with its cover 711 installed on the housing 705. The IR linear sensing strip 701 in accordance with an embodiment is likewise controllable by placing a finger on the photodiode 713, tapping the photodiode 713 or sliding a finger in either direction of the arrows 709 to invoke various controls and other features without causing obstruction of the display 703. The IR linear sensing strip 701 is positioned to one side of the display, which may be a touchscreen display in some embodiments. The housing 705 may be connected to a wristband at for example connection point 707 on either side of the housing 705.

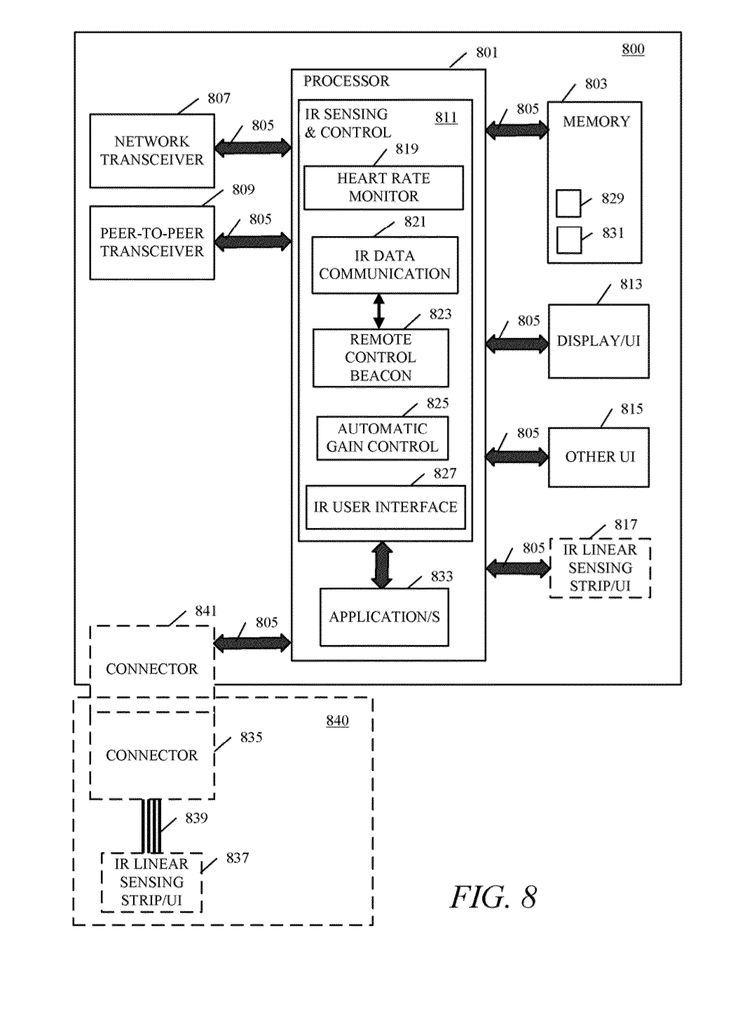

FIG. 8 is a partial schematic diagram of a mobile device 800, which may also be a wearable device similar to that shown in FIG. 6 or FIG. 7, in accordance with various embodiments. FIG. 8 provides an example for the purpose of describing to those of ordinary skill how to make and use the various embodiments. Therefore FIG. 8 is a partial schematic block diagram in that it is limited to showing only those components necessary to describe the features and advantages of the various embodiments to those of ordinary skill. It is to be understood that various other components, circuitry, and devices may be necessary in order to implement a complete functional apparatus (such as a mobile device or wearable device) and that those various other components, circuitry, devices, etc., are understood to be present by those of ordinary skill.

The mobile device 800 is an apparatus in accordance with an embodiment and may be a mobile communication device, a mobile device wearable on a user's wrist or some other electronic device. An internal communication bus 805 provides operative coupling between various components such as at least one processor 801 and a display/UI 813 which may provide a user interface (UI) such as a graphical user interface (GUI) or a touchscreen. The communication bus 805 may run throughout the mobile device 800 providing operative coupling between any of the various components, circuitry, and the like, contained therein. The communication bus 805 provides operative coupling in that various intervening device components, circuitry, and the like, may exist in between, and/or along, the communication path between any two or more operatively coupled components, etc. As shown in FIG. 8, the processor 801 is operatively coupled by the communication bus 805 to memory 803, other user interfaces (UI) 815, display/UI 813, network transceiver 807, peer-to-peer transceiver 809, and to the infrared (IR) linear sensing strip/UI 817.

The network transceiver 807 may provide wireless communication capabilities for one or more wide area network communications systems such as, but not limited to, 3G or 4G wireless communications systems. The peer-to-peer transceiver 809 may provide wireless connectivity capabilities such as, but not limited to, Bluetooth™, Wireless USB, ZigBee, or other technologies, etc. The other UI 815 may include a track ball mouse, touch sensitive elements, physical switches, gyroscopic position sensors, etc., and notification systems such as LED visual indicators. The display/UI 813 may include touchscreen functionality and may be operative to receive command and control signals from the other UI 815 or the IR linear sensing strip/UI 817 directly, or via the processor 801, for functions such as, but not limited to, mouse cursor control click to provide selection input and or drag and drop features, scrolling or other functionality. The memory 803 is a non-volatile, non-transitory memory, and may store a user profile 829 which may include user settings and may store received information 831 that may be received via the IR linear sensing strip/UI 817.

The processor 801 may be operative to run infrared (IR) sensing and control 811 logic in accordance with the embodiments, which may require executing executable instructions (i.e. code) stored in memory 803. However, the IR sensing and control 811 logic and any of its component modules may be implemented independently as software and/or firmware executing on one or more programmable processors such as processor 801 (including CPUs and/or GPUs), and may also include ASICs, DSPs, hardwired circuitry (logic circuitry), or combinations thereof, and are not limited to executable instructions as an implementation.

The various embodiments may also include non-volatile, non-transitory computer readable memory, other than memory 803, that may contain executable instructions, for execution by at least one processor, that when executed, cause the at least one processor to operate in accordance with the IR sensing and control 811 logic functionality herein described. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other mobile devices or wearable devices such as those that may benefit from the features of the herein described embodiments.

The IR sensing and control 811 logic may consist of various component modules such as a heart rate monitor 819, IR data communication 821, remote control beacon 823, automatic gain control 825, and IR user interface 827. Each of these modules are operatively coupled to each other and are operative to provide information and/or command and control signals to each other as needed. For example, the IR data communication 821 and remote control beacon 823 modules are operatively coupled and may work cooperatively to provide various features described below. The processor 801 may also execute and run various applications 833 that may also provide information or receive information, including command and control signals, to and from the IR sensing and control 811 logic and any of the component modules as needed. In some embodiments, an IR linear sensing strip/UI 837 may be located on an external apparatus 840 in lieu of, or in addition to, the IR linear sensing strip/UI 817 which is installed within the housing of mobile device 800.

For operation of the externally located IR linear sensing strip/UI 837, the processor 801 may be operatively connected, via connectors 841 and 835, to the IR linear sensing strip/UI 837 which is located on the external apparatus 840. The connector 835 is connected to the IR linear sensing strip/UI 837 via connection lines 839 which may be flexible connection lines in some embodiments. The external apparatus 840 may be a wristband where the connectors 841 and 835 are flexible and form a flexible connection between the wristband and mobile device 800 where mobile device 800 is wearable similar to a wristwatch. In other embodiments, the external apparatus 840 may be a stationary docking station, such as a car dock, desk dock or similar docking station. In such embodiments, the connectors 841 and 835 are docking connectors between the mobile device 800 and the docking station (i.e. the external apparatus 840). The IR linear sensing strip/UI 837 provides control features by interacting with the external apparatus 840 rather than having to touch the mobile device 800 controls such as display/UI 813 or other UI 815.

In embodiments having a docking station, the IR user interface 827 module may receive inputs via the internal communication bus 805 indicating that the external apparatus 840 has been connected. The IR user interface 827 module may temporarily disable the IR linear sensing strip/UI 817 (if present in the mobile device 800) and allow command and control to be received only from the external IR linear sensing strip/UI 837 until the mobile device 800 is removed from the docking station (i.e. removed from external apparatus 840). In embodiments where the external apparatus 840 is a wristband, the external IR linear sensing strip/UI 837 provides the various features and the IR linear sensing strip/UI 817 may not be present in the mobile device 800. That is, the various components shown as dotted lines in FIG. 8 may or may not be present depending on the specific embodiment. However, at least one of either IR linear sensing strip/UI 817 or external IR linear sensing strip/UI 837 will be present in the various embodiments.

Methods of operation of the IR linear sensing strip/UI 817 or 837, the IR sensing and control 811 logic and the various component modules are described below with respect to the flow charts of FIGS. 10, 11 and 12. It is to be understood that the below described methods of operation are applicable regardless of whether the IR linear sensing strip/UI is located within the mobile device 800 or within the external apparatus 840.

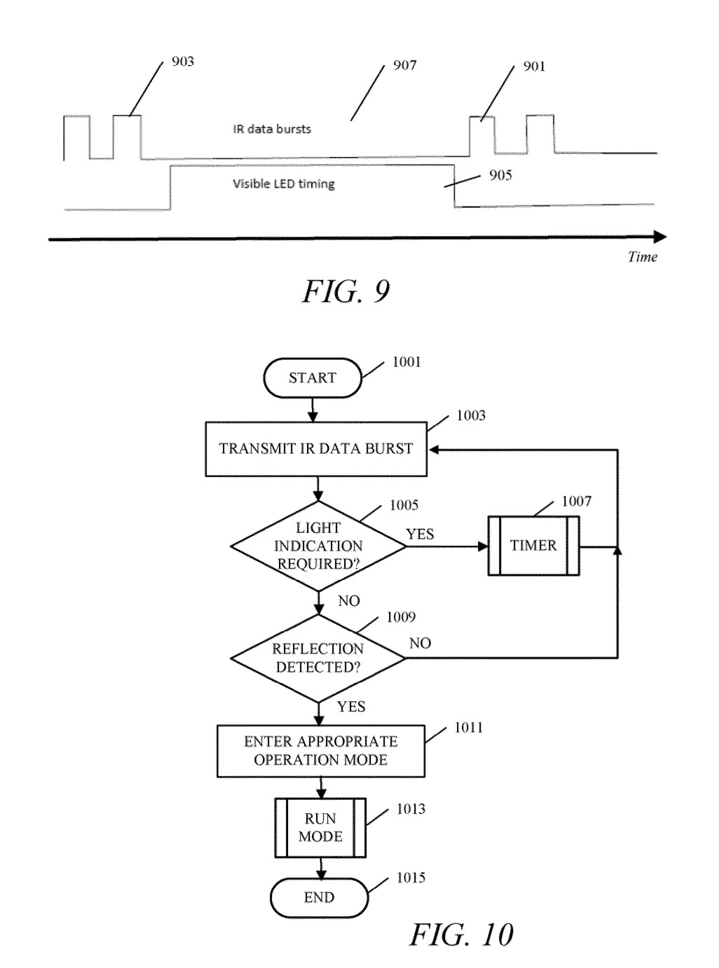

FIG. 9 is a pulse timing diagram for methods of operation illustrated by the flowchart of FIG. 10. FIG. 9 shows how interference avoidance is used between infrared data bursts and visible light LED indicators in accordance with various embodiments. As was mentioned previously, the other UI 815 may include visual notification LEDs that emit visible light. This visible light may cause undesired interference with the light emitted from the IR linear sensing strip/UI 817. The IR user interface 827 module, of the IR sensing and control 811 logic, modulates IR data bursts emitted by the IR linear sensing strip/UI 817 in order to avoid light interference from such notification LEDs. That is, the IR user interface 827 module is able to determine when a visible LED indication or notification will be provided by the processor 801 using a notification LED of the other UI 815 and act accordingly. As shown in FIG. 9, when a visible LED indication is forthcoming, the IR user interface 827 module (or the IR data communication 821 module) sends a final IR data burst 901 and then stops transmitting for a silent period 907. The silent period 907 lasts long enough to allow the visible LED timing 905 to occur and expire such that any visible light LED indicator is extinguished. After completion of the visible LED timing 905, another IR data burst 903 may be transmitted such that the IR linear sensing strip/UI 817 resumes operation. Such modulation of the IR data bursts may be applied for various purposes including avoiding interference when using the IR linear sensing strip/UI 817 to perform remote control functions or other functions where the IR linear sensing strip/UI 817 must emit and receive infrared light.

A method of operation related to the timing diagram of FIG. 9 is illustrated by the flowchart of FIG. 10. The method of operation begins in block 1001, and in block 1003 the IR linear sensing strip/UI 817 transmits an IR data burst. The IR user interface 827 module of the IR sensing and control 811 logic determines in decision block 1005 whether a light indication is required and will be transmitted. If yes, timer 1007 begins operation such that the IR silent period 907 as shown in FIG. 9 allows transmission of the visible light LED notification. After the timer 1007 times out, transmission of an IR data burst in block 1003 may again resume. When no light indication is required in decision block 1005, the IR user interface 827 module checks the IR linear sensing strip/UI 817 photodiode (i.e. the receiver diode) to determine whether reflection is detected as shown in decision block 1009. If not, then transmission of IR data bursts can continue as shown in block 1003. If reflection is detected in decision block 1009, then the IR sensing and control 811 logic will enter an appropriate operation mode is shown in block 1011 and the processor 801 will run the mode of operation is shown in block 1013. After the mode of operation in block 1013 is completed, the method of operation ends in block 1015 as shown.

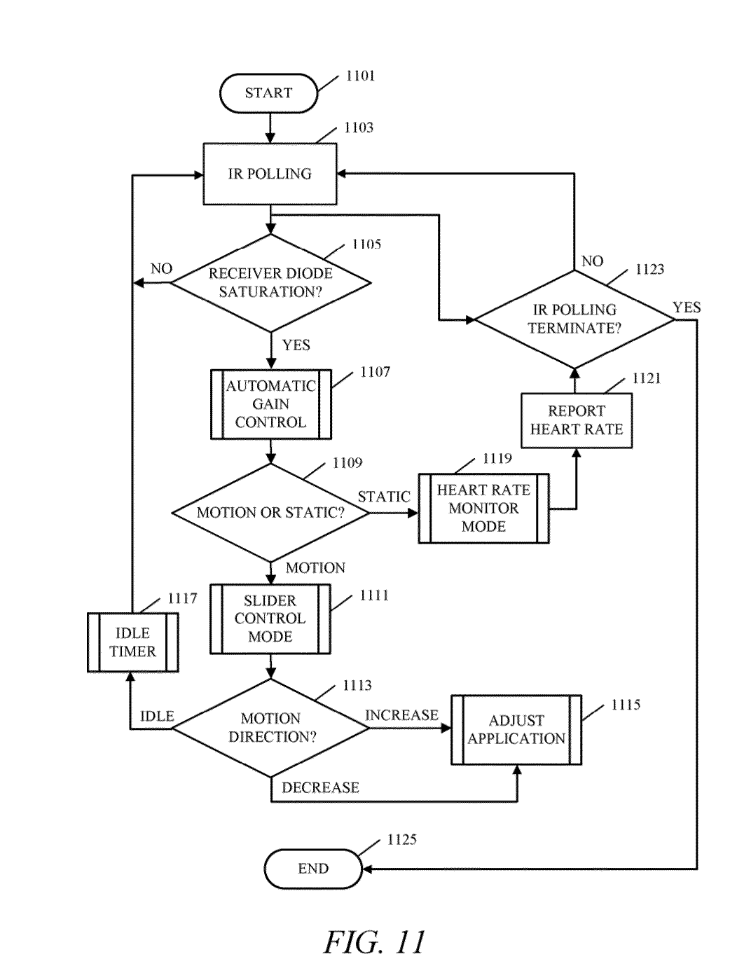

The flowchart of FIG. 11 shows methods of operation of the IR linear sensing strip/UI 817 as well as how the IR sensing and control 811 logic enters various modes of operation and invokes the various component modules such as the heart rate monitor 819, the IR data communication 821 and remote control beacon 823 modules, the automatic gain control 825 and the IR user interface 827 module. The methods of operation begins in block 1101, and in block 1103 IR polling begins by firing LEDs of the IR linear sensing strip/UI 817 and checking for reflections at the centrally positioned receiver diode. In some modes of operation, for example where user places a finger over the receiver diode and holds it there in place for a period of time, the receiver diode may go into saturation. The IR user interface 827 module monitors for such conditions and the automatic gain control 825 is applied to the receiver diode so as to implement control functions similar to a capacitive touch control. That is, if the receiver diode goes into saturation as shown in decision block 1105, the automatic gain control 825 is invoked as shown in operation block 1107. So long as no receiver diode saturation is detected in decision block 1105, IR polling continues as shown in block 1103. The IR user interface 827 will also make a determination of whether the user is placing a finger statically upon the IR linear sensing strip/UI 817 or is conducting some gesture or motion across the strip as shown in decision block 1109. For example, in one embodiment, if a static position of the user's finger is detected based on the receiver diode saturation, the IR sensing and control 811 logic may enter a heart rate monitor mode as shown in operation block 1119, and will invoke the heart rate monitor 819 module. The heart rate monitor 819 module will detect and measure the user's heart rate via the user's finger placed upon the receiver diode, and will report the heart rate in block 1121 by, for example, displaying the numerical heart rate on the display/UI 813. The IR polling may be terminated, as shown in decision block 1123, by some user action such as, but not limited to, shutting down the mobile device 800 or possibly disabling the IR user interface 827 module by changing some setting input. If no such termination occurs in decision block 1123, then IR polling continues as shown in operation block 1103. However, if the IR polling is terminated in decision block 1123 by the user shutting down the mobile device 800 or by taking some other action, the method of operation ends as shown in block 1125.

Returning to decision block 1109, if the IR user interface 827 module determines that the user has made some motion with respect to the IR linear sensing strip/UI 817, then the IR sensing and control 811 logic may invoke a slider control mode in operation block 1111 which may be used for various control functions such as scrolling, volume increase and decrease, camera zoom or some other appropriate feature that may benefit from the slider control mode of operation block 1111. The IR user interface 827 will determine the motion direction, as shown in decision block 1113, to provide either an increase control signal or a decrease control signal to adjust an application as shown in operation block 1115. The motion direction decision block 1113 may receive feedback from the application such that a stable control signal may be provided. More specifically, the IR user interface 827 may receive a feedback signal from one of the applications 833 that is being adjusted by the IR linear sensing strip/UI 817 control signal to achieve control signal stability as understood by those of ordinary skill.

If no motion direction is detected in decision block 1113, the user may have done nothing such that the IR linear sensing strip/UI 817 remains in an idle state. In other words, the IR user interface 827 may have detecting only an anomalous motion that was not due to an intended control gesture. In this case an idle timer operation 1117 may be used to prevent unintended control operation of the IR linear sensing strip/UI 817. If the IR linear sensing strip/UI 817 is idle, then normal IR polling continues as shown in operation block 1103. That is, the idle timer operation 1117 may prevent anomalous control signals from being sent to an application. The IR user interface 827 module looks for motion, such as a gesture across the IR linear sensing strip UI 817 in one direction or the other, and takes appropriate action with respect to adjusting the appropriate application. Otherwise, if the IR linear sensing strip/UI 817 does not have any reflection detected by the receiver diode that is considered long enough in duration then the system is considered to still be idle by the IR user interface 827 module. IR polling in block 1103 continues, notwithstanding any anti-interference modulation as previously described, to detect user input via reflections of IR light detected by the receiver diode.

Although the flowchart of FIG. 11 provides example methods of operation with respect to a heart rate monitor mode and a slider control mode, those of ordinary skill may envision other applications given the descriptions and disclosure provided herein. All such applications that may be envisioned by those of ordinary skill are contemplated by the present disclosure and remain in accordance with the various embodiments herein disclosed.

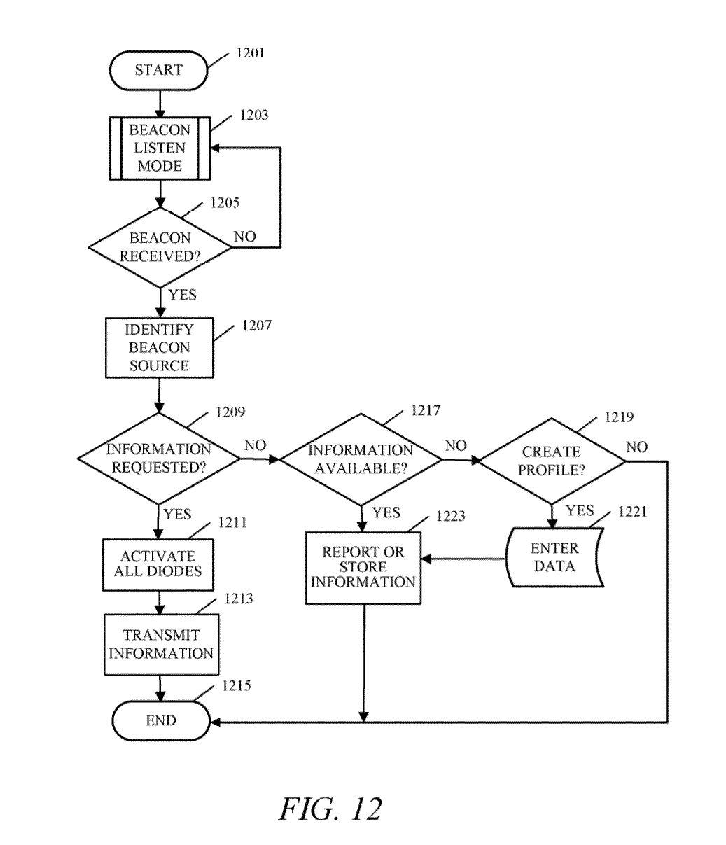

Various methods of operation employing the IR data communication 821 module and the remote control beacon 823 module are illustrated by the flowchart of FIG. 12. The methods of operation begin in block 1201 and the IR sensing and control 811 logic enters a beacon listen mode as shown in operational block 1203. That is, any infrared data received by the IR linear sensing strip/UI 817 is handled by the IR data communication 821 module accordingly. The IR data communication 821 module may include an appropriate software stack for infrared communications such as an IrDA infrared communications standard software stack or some other infrared communications standard, or some proprietary infrared communications standard. Such software may be preprogrammed into the IR sensing and control 811 logic, or stored as some other executable instructions, during factory provisioning of mobile device 800 or during provisioning by a mobile device network operator. If a beacon is received at decision block 1205, the IR data communication 821 module will identify the beacon source in block 1207 and determine if information is requested by the source as shown in decision block 1209. If no beacon is received in decision block 1205 then the IR data communication 821 module will continue operating in beacon listen mode in block 1203.

If information is requested by the beacon source in decision block 1209, then the IR data communication 821 module will activate all diodes of the IR linear sensing strip/UI 817 as shown in block 1211 and may then transmit the requested information as shown in block 1213. The information sent may be the user profile 829 stored in memory 803 or some other information. The method of operation ends in block 1215 as shown. If no information is requested by the beacon source in decision block 1209, then the IR data communication 821 module may determine if information is available from the beacon source as shown in decision block 1217. If yes, the IR data communication 821 module may receive the information via the IR linear sensing strip/UI 817 and subsequently report or store the information is shown in block 1223. That is, the information may be stored as received information 831 stored in memory 803 or reported by displaying it on display/UI 813. If no information is available in decision block 1217, then the IR data communication 821 module may check with the beacon source to see if it is possible to create a user profile as shown in decision block 1219. If not, the method of operation ends as shown in block 1215. If yes, the user may enter data as shown in data entry block 1221 using either the display/UI 813, or other UI 815, which may then be reported or stored as shown in operation block 1223. The method of operation then ends in block 1215. The information stored or reported in block 1223 may be the user profile 829 which has been generated by data entry at data entry block 1221. Some example use cases corresponding to the methods of operation illustrated by FIG. 12 will now be described.

In one use case scenario, a user may have a wearable device strapped to their wrist which contains user profile 829 and that contains various device settings. For example, an automobile may have various settings such as seat height, tilt, seat distance from the gas and brake pedals, steering wheel height and tilt, rearview mirror adjustment, or other settings and adjustments specific to the user. Upon entry into the vehicle by the user, the automobile may emit an infrared beacon that is detected by the user's wearable device. The wearable device identifies the beacon source as was discussed with respect to operation block 1207. That is, the automobile may request information in decision block 1209 from the user's wearable device, such as the user profile 829. The wearable device may then activate all diodes of the IR linear sensing strip/UI 817 and transmit the information as shown in operation blocks 1211 and 1213. At that point the beacon source, which is the automobile control system, may apply the user profile 829 settings and make various adjustments for the user's comfort or safety before the user operates the vehicle.

Alternatively, if no user profile exists in memory 803 for the specific user, the wearable device may check if information is available to be received from the beacon source as shown in decision block 1217. For example, the information may include the make, model, and year of the vehicle such that an appropriate user profile or appropriate settings may be provided through a user interface. For example, the user may see the vehicle information and available settings or other controls on the display/UI 813 as a report in operation block 1223. The user may store the information in memory 803 as received information 831. In another alternative, the automobile control system may allow the user to create a new user profile as shown in decision block 1219. The user may be allowed to enter data at data entry block 1221 via the wearable device or via a user interface of the vehicle. The generated user profile may then be saved as the user profile 829 stored by the wearable device in block 1223 for future use by the user in the same or a different vehicle of the same kind.

Another use case scenario involves a notification or security system at a business or home. The business or home may have a source infrared beacon that sends information to individuals approaching an entryway to the business or home. The user's wearable device operates in the beacon listen mode as in operation block 1203 and the beacon is received in decision block 1205. The wearable device identifies the beacon source in operation block 1207, and determines if information is requested in decision block 1209. For example, the home or business may request identity information from the user's wearable device or some other information such as purpose of visit etc. Using the methods of operation described above with respect to FIG. 12, the wearable device may provide information to the beacon source or the user may be allowed to retrieve information or set up a profile or etc. Alternative to the above described system, the wearable device may transmit the beacon and a home or business notification or security system may perform the operations illustrated by the flowchart of FIG. 12. Various other use case scenarios and systems may be envisioned by those of ordinary skill in given the methods of operation and use case scenarios described in disclosed herein.

In another use case scenario, the wearable device may be used as a personal remote control for various devices capable of receiving an infrared control signal. The IR data communication 821 module in conjunction with the remote control beacon 823 module may control the IR linear sensing strip/UI 817 to send control signals to various devices based on settings stored in the user profile 829. For example, a user may have television channel programming, volume, or other settings stored in the user profile 829 that may be sent to a television after initial detection of a beacon emanating from the television to inform the wearable device that it is in the television's vicinity. Alternatively, the wearable device may transmit the beacon and receive confirmation from the device. Various other use case scenarios may be envisioned by those of ordinary skill given the above described methods of operation and example use case scenarios described herein.

An IR linear sensing strip/UI and various mobile devices, including wearable mobile devices, that utilize the described IR linear sensing strip/UI have been disclosed and described along with various example methods of operation and example use case scenarios that provide the various benefits and advantages obtained by the IR linear sensing strip/UI disclosed and described herein. Although example use cases have been provided involving mobile devices, it is to be understood that the IR linear sensing strip/UI herein disclosed may be used in various applications that involve other devices, other than mobile devices and that therefore the various embodiments are not limited to mobile devices. For example, a thermostat positioned on a wall, a light switch or dimmer switch positioned on a wall, home appliances, etc., may all benefit from the features and advantages of the disclosed IR linear sensing strip/UI. In addition, it has been discovered that the IR linear sensing strip/UI disclosed and described in FIG. 1 through FIG. 5 is particularly advantageous for use in a heart rate monitor due to the close proximity of the various LEDs to the centrally positioned photodiode (receiver diode) which allows multiple sources of reflection through the user's finger when positioned relatively stationary upon the centrally positioned photodiode. That is, unexpected advantageous results for use of the herein described and disclosed IR linear sensing strip/UI have been discovered for the various embodiments disclosed herein that are advantageous over other types of infrared sensing configurations that may be used for heart rate monitoring.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. An infrared sensing strip, comprising:
a substantially linear substrate board;
a receiver diode;
a plurality of light emitting diodes (LEDs) linearly aligned along the linear substrate board, each LED operative to transmit in a different direction.

2. The infrared sensing strip of claim 1, further comprising:
a plurality of prismatic films, each prismatic film covering a respective one of the plurality of LEDs, the prismatic films arranged to refract light from each respective LED in one of the different directions.

3. The infrared sensing strip of claim 1, wherein the receiver diode is positioned centrally on the linear substrate board; and
wherein the plurality of LEDs comprises at least four LEDs, two of each being disposed on either side of the receiver diode; and
at least four prismatic films, each prismatic film covering a respective one of the at least four LEDs, the prismatic films arranged to refract light from each respective LED in one of four different directions.

4. The infrared sensing strip of claim 1, further comprising:
an optical isolation shield, surrounding the receiver diode;
a lens covering the at least four LEDs and the at least four prismatic films; and
at least one spacing layer between the linear substrate board and the lens.

5. The infrared sensing strip of claim 1, wherein the infrared sensing strip has a length of approximately 20 millimeters.

6. The infrared sensing strip of claim 5, wherein the infrared sensing strip has a width of approximately 7 millimeters.

7. The infrared sensing strip of claim 5, wherein the infrared sensing strip thickness measured from t the lens top surface to the substrate bottom surface is between 3 and 4 millimeters.

8. A mobile device comprising the infrared sensing strip of claim 1.

9. The mobile device of claim 8, further comprising:
a touchscreen display, wherein the infrared sensing strip is positioned to one side of the touchscreen display such that the infrared sensing strip is operable as a user interface without obstructing the display from view.

10. The mobile device of claim 8, further comprising:
heart rate monitor logic, operatively coupled to the infrared sensing strip, the heart rate monitor logic operative to measure a heart rate in response to a human finger placed upon a surface of the infrared sensing strip.

11. The mobile device of claim 8, further comprising:
sensing and control logic, operatively coupled to the infrared sensing strip, the sensing and control logic operative to provide an increase or decrease control signal in response to motion over the infrared sensing strip in a given direction.

12. The mobile device of claim 8, further comprising:
sensing and control logic, operatively coupled to the infrared sensing strip, the sensing and control logic operative to detect a beacon signal via the infrared sensing strip and return information using the infrared sensing strip to transmit the information.

13. The mobile device of claim 8, further comprising:
a wrist band, connected to a housing of the mobile device wherein the infrared sensing strip is housed within the wrist band, the infrared sensing strip operatively coupled to the mobile device via a flexible connector between the mobile device and the wrist band.

14. The mobile device of claim 11 wherein the mobile device is a camera and wherein the sensing and control logic operative to provide the increase or decrease control signal to control the camera lens to zoom in or out, respectively.

15. The mobile device of claim 11 wherein the sensing and control logic operative to provide the increase or decrease control signal to control an audio volume.

16. The mobile device of claim 9, further comprising:
sensing and control logic, operatively coupled to the infrared sensing strip, the sensing and control logic operative to provide an increase or decrease control signal in response to motion over the infrared sensing strip in a given direction to control scrolling on the touchscreen display.

17. A system, comprising:
a docking station, comprising:
a first docking connector; and
an infrared sensing strip, operatively coupled to the first docking connector, the infrared sensing strip comprising:
a substantially linear substrate board;
a receiver diode, positioned centrally on the linear substrate board;
at least four light emitting diodes (LEDs), two of each being disposed on either side of the receiver diode and linearly aligned along the linear substrate board; and
at least four prismatic films, each prismatic film covering a respective one of the at least four LEDs, the prismatic films arranged to refract light from each respective LED in one of four different directions; and
a mobile device, comprising:
a second docking connector, operative to connect to the first docking connector;
sensing and control logic, operatively coupled to the second docking connector, the sensing and control logic operative to receive control signals from the infrared sensing strip.
